(19) United States
(12) Patent Application Publication
(10) Pub. No.: US 2025/0119804 A1
(43) Pub. Date: Apr. 10, 2025

(54) MOBILITY PROCEDURES FOR NON-TERRESTRIAL NETWORK (NTN) DEVICES

(71) Applicant: QUALCOMM Incorporated, San Diego, CA (US)

(72) Inventors: Ansah Ahmed SHEIK, Hyderabad (IN); Rishika TINDOLA, Hyderabad (IN); Muralidharan MURUGAN, Hyderabad (IN); Sohrab AHMAD, Hyderabad (IN); Nilotpal DHAR, Hyderabad (IN)

(21) Appl. No.: 18/484,218

(22) Filed: Oct. 10, 2023

(51) Int. Cl. H04W 36/08; H04W 36/00

(52) U.S. Cl. CPC H04W 36/083; H04W 36/0077

(57) ABSTRACT

Methods, systems, and devices for wireless communications are described. A user equipment (UE) may receive from a first cell of a non-terrestrial network (NTN), a broadcast signal indicating respective parameters associated with the first cell and one or more target cells of the NTN that are different from the first cell. In some examples, the respective parameters associated with cell selection or cell reselection. The UE may store the respective parameters associated with the one or more target cells of the NTN. The UE may perform a cell selection procedure or a cell reselection procedure with a first target cell of the one or more target cells of the NTN using stored respective parameters associated with the first target cell.

### FIELD OF TECHNOLOGY

The following relates to wireless communications, including mobility procedures for non-terrestrial network (NTN) devices.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support mobility procedures for non-terrestrial network (NTN) devices. For example, the described techniques provide for wireless devices of an NTN to reduce signaling overhead and latency associated with cell selection and cell reselection. A current serving NTN cell may transmit to a set of user equipments (UEs) respective parameters associated with target NTN cells to use in the event of cell selection or cell reselection. In some cases, the serving NTN cell may transmit broadcast signal that includes a respective master information block (MIB) and system information block 1 (SIB1) for each of a set of target NTN cells. As such, the set of UEs may perform a pre-validation and suitability check for a given cell prior to performing a cell selection or cell reselection procedure with the given cell. In some examples, the serving NTN cell may explicitly indicate the MIB and SIB1 for a given target cell (e.g., a first string of bits indicating the MIB and a second string of bits indicating the SIB1). In some examples, the serving NTN cell may indicate delta MIB and SIB1 parameters for a given target cell that are relative to the MIB and SIB1 of the serving NTN cell. In some examples, the serving NTN cell may include multiple sub-cell sectors that each correspond to a different geographic coverage area. As such, each sub-cell sector may correspond to a respective set of UEs serviced by the serving NTN cell. In some examples, the serving NTN cell may indicate respective target cells on a per sub-cell sector basis.

A method for wireless communications by a UE is described. The method may include receiving, from a first cell of an NTN, a broadcast signal indicating respective parameters associated with the first cell and one or more target cells of the NTN that are different from the first cell, the respective parameters associated with cell selection or cell reselection, storing the respective parameters associated with the one or more target cells of the NTN, and performing a cell selection procedure or a cell reselection procedure with a first target cell of the one or more target cells of the NTN using stored respective parameters associated with the first target cell.

A UE for wireless communications is described. The UE may include one or more memories storing processor executable code, and one or more processors coupled with the one or more memories. The one or more processors may individually or collectively operable to execute the code to cause the UE to receive, from a first cell of an NTN, a broadcast signal indicating respective parameters associated with the first cell and one or more target cells of the NTN that are different from the first cell, the respective parameters associated with cell selection or cell reselection, store the respective parameters associated with the one or more target cells of the NTN, and perform a cell selection procedure or a cell reselection procedure with a first target cell of the one or more target cells of the NTN using stored respective parameters associated with the first target cell.

Another UE for wireless communications is described. The UE may include means for receiving, from a first cell of an NTN, a broadcast signal indicating respective parameters associated with the first cell and one or more target cells of the NTN that are different from the first cell, the respective parameters associated with cell selection or cell reselection, means for storing the respective parameters associated with the one or more target cells of the NTN, and means for performing a cell selection procedure or a cell reselection procedure with a first target cell of the one or more target cells of the NTN using stored respective parameters associated with the first target cell.

A non-transitory computer-readable medium storing code for wireless communications is described. The code may include instructions executable by a processor to receive, from a first cell of an NTN, a broadcast signal indicating respective parameters associated with the first cell and one or more target cells of the NTN that are different from the first cell, the respective parameters associated with cell selection or cell reselection, store the respective parameters associated with the one or more target cells of the NTN, and perform a cell selection procedure or a cell reselection procedure with a first target cell of the one or more target cells of the NTN using stored respective parameters associated with the first target cell.

In some examples of the method, UEs, and non-transitory computer-readable medium described herein, performing the cell selection procedure or the cell reselection procedure may include operations, features, means, or instructions for identifying a radio link failure for a first radio link between the UE and the first cell, determining the first target cell as a candidate cell for cell selection using the stored respective parameters associated with the first target cell, and establishing a second radio link between the UE and the first target cell using the stored respective parameters associated with the first target cell.

Some examples of the method, UEs, and non-transitory computer-readable medium described herein may further include operations, features, means, or instructions for determining a first frequency associated with the first target cell using the stored respective parameters associated with the first target cell and measuring, via the first frequency associated with the first target cell, one or more cell suitability criteria, where determining the first target cell as the candidate cell for cell selection or cell reselection may be based on the first target cell satisfying the one or more cell suitability criteria.

In some examples of the method, UEs, and non-transitory computer-readable medium described herein, the one or more cell suitability criteria includes one or more of a reference signal received power (RSRP) value of the first target cell, a reference signal received quality (RSRQ) value of the first target cell, a cell load of the first target cell, a cell identifier of the first target cell, quality of service (QoS) parameters of the first target cell, a signal to noise ratio (SNR) value of the first target cell, the first frequency of the first target cell, a coverage area overlap between the first target cell and the first cell, a public land mobile network (PLMN) or tracking area code (TAC) of the first target cell, or a status of the first target cell.

In some examples of the method, UEs, and non-transitory computer-readable medium described herein, the respective parameters indicate a respective MIB and a respective SIB1 for each target cell of the one or more target cells.

In some examples of the method, UEs, and non-transitory computer-readable medium described herein, the respective MIB for a given target cell may be indicated via a first string of bits and the respective system information block (SIB)1 for the given target cell may be indicated via a second string of bits.

In some examples of the method, UEs, and non-transitory computer-readable medium described herein, the respective MIB for a given target cell may be indicated via a set of delta MIB parameters relative to a first MIB of the first cell, and the respective SIB1 for the given target cell may be indicated via a set of delta SIB1 parameters relative to a first SIB1 of the first cell.

In some examples of the method, UEs, and non-transitory computer-readable medium described herein, the set of delta SIB1 parameters include one or more of a frequency, a TAC, a PLMN identifier, and a signal strength threshold for cell selection or cell reselection.

In some examples of the method, UEs, and non-transitory computer-readable medium described herein, the first cell includes a set of sub-cell sections each associated with a respective geographic coverage area and a geographic location of the UE may be within the respective geographic coverage area of a first sub-cell section of the set of sub-cell sections.

In some examples of the method, UEs, and non-transitory computer-readable medium described herein, the one or more target cells associated with the broadcast signal and the respective parameters associated with the one or more target cells may be based on the geographic location of the UE being with the respective geographic coverage area of the first sub-cell section.

In some examples of the method, UEs, and non-transitory computer-readable medium described herein, the UE may be moving relative to a terrestrial plane, performing a handover procedure may include operations, features, means, or instructions for measuring, via a respective frequency associated with each target cell of the one or more target cells within a range of a geographic location of the UE, a respective RSRP value and determining one or more candidate cells for handover from the one or more target cells, where each candidate cell of the one or more candidate cells may have a respective RSRP value that satisfies a threshold.

A method for wireless communications by an NTN entity including a first cell of an NTN is described. The method may include calculating a trajectory of the first cell with respect to a set of multiple UEs served by the first cell, the trajectory of the first cell based on ephemeris information associated with the NTN entity and transmitting, a broadcast signal from the first cell indicating respective parameters associated with one or more target cells of the NTN, the respective parameters associated with a cell selection or cell reselection from the first cell, where the one or more target cells and the respective parameters are based on the ephemeris information associated with the NTN entity.

An NTN entity including a first cell of an NTN for wireless communications is described. The NTN entity including a first cell of an NTN may include one or more memories storing processor executable code, and one or more processors coupled with the one or more memories. The one or more processors may individually or collectively operable to execute the code to cause the NTN entity including a first cell of an NTN to calculate a trajectory of the first cell with respect to a set of multiple UEs served by the first cell, the trajectory of the first cell based on ephemeris information associated with the NTN entity and transmit, a broadcast signal from the first cell indicating respective parameters associated with one or more target cells of the NTN, the respective parameters associated with a cell selection or cell reselection from the first cell, where the one or more target cells and the respective parameters are based on the ephemeris information associated with the NTN entity.

Another NTN entity including a first cell of an NTN for wireless communications is described. The NTN entity including a first cell of an NTN may include means for calculating a trajectory of the first cell with respect to a set of multiple UEs served by the first cell, the trajectory of the first cell based on ephemeris information associated with the NTN entity and means for transmitting, a broadcast signal from the first cell indicating respective parameters associated with one or more target cells of the NTN, the respective parameters associated with a cell selection or cell reselection from the first cell, where the one or more target cells and the respective parameters are based on the ephemeris information associated with the NTN entity.

A non-transitory computer-readable medium storing code for wireless communications is described. The code may include instructions executable by a processor to calculate a trajectory of the first cell with respect to a set of multiple UEs served by the first cell, the trajectory of the first cell based on ephemeris information associated with the NTN entity and transmit, a broadcast signal from the first cell indicating respective parameters associated with one or more target cells of the NTN, the respective parameters associated with a cell selection or cell reselection from the first cell, where the one or more target cells and the respective parameters are based on the ephemeris information associated with the NTN entity.

In some examples of the method, NTN entity, and non-transitory computer-readable medium described herein, the respective parameters indicate a respective MIB and a respective SIB1 for each target cell of the one or more target cells.

In some examples of the method, NTN entity, and non-transitory computer-readable medium described herein, the respective MIB for a given target cell may be indicated via a first string of bits and the respective SIB1 for the given target cell may be indicated via a second string of bits.

In some examples of the method, NTN entity, and non-transitory computer-readable medium described herein, the respective MIB for a given target cell may be indicated via a set of delta MIB parameters relative to a first MIB of the first cell, and the respective SIB1 for the given target cell may be indicated via a set of delta SIB1 parameters relative to a first SIB1 of the first cell.

In some examples of the method, NTN entity, and non-transitory computer-readable medium described herein, the set of delta SIB1 parameters include one or more of a frequency, a TAC, a PLMN identifier, and a signal strength threshold for cell selection or cell reselection.

In some examples of the method, NTN entity, and non-transitory computer-readable medium described herein, the first cell includes a set of sub-cell sections each associated with a respective geographic coverage area and a respective geographic location of each of the set of multiple UEs may be within the respective geographic coverage area of a first sub-cell section of the set of sub-cell sections.

In some examples of the method, NTN entity, and non-transitory computer-readable medium described herein, the one or more target cells associated with the broadcast signal may be based on the respective geographic location of each of the set of multiple UEs being with the respective geographic coverage area of the first sub-cell section.

Some examples of the method, NTN entity, and non-transitory computer-readable medium described herein may further include operations, features, means, or instructions for receiving a respective TAC from each UE of the set of multiple UEs, where the respective geographic location of each of the set of multiple UEs may be determined based on the respective TAC from each UE of the set of multiple UEs.

In some examples of the method, NTN entity, and non-transitory computer-readable medium described herein, the NTN entity includes the one or more target cells, one or more second NTN entities include the one or more target cells, or both.

### BRIEF DESCRIPTION OF THE DRAWINGS

FIG. 1 shows an example of a wireless communications system that supports mobility procedures for NTN devices in accordance with one or more aspects of the present disclosure.

FIG. 2 shows an example of a wireless communications system that supports mobility procedures for NTN devices in accordance with one or more aspects of the present disclosure.

FIG. 3 shows an example of a cell sector configuration that supports mobility procedures for NTN devices in accordance with one or more aspects of the present disclosure.

FIG. 4 shows an example of a process flow that supports mobility procedures for NTN devices in accordance with one or more aspects of the present disclosure.

FIGS. 5 and 6 show block diagrams of devices that support mobility procedures for NTN devices in accordance with one or more aspects of the present disclosure.

FIG. 7 shows a block diagram of a communications manager that supports mobility procedures for NTN devices in accordance with one or more aspects of the present disclosure.

FIG. 8 shows a diagram of a system including a device that supports mobility procedures for NTN devices in accordance with one or more aspects of the present disclosure.

FIGS. 9 and 10 show block diagrams of devices that support mobility procedures for NTN devices in accordance with one or more aspects of the present disclosure.

FIG. 11 shows a block diagram of a communications manager that supports mobility procedures for NTN devices in accordance with one or more aspects of the present disclosure.

FIG. 12 shows a diagram of a system including a device that supports mobility procedures for NTN devices in accordance with one or more aspects of the present disclosure.

FIGS. 13 through 15 show flowcharts illustrating methods that support mobility procedures for NTN devices in accordance with one or more aspects of the present disclosure.

### DETAILED DESCRIPTION

In some examples, one or more user equipments (UEs) may communicate with a non-terrestrial network (NTN) that leverages NTN devices (e.g., satellites, high-altitude platforms (HAPs), and other aerial or space-based platforms) to provide connectivity and communication services. In some examples, a set of UEs may be served by a first NTN cell of an NTN entity that may move relative to the set of UEs. As the first NTN cell moves out of service range for the set of UEs, the quality of the radio link corresponding to the first NTN cell may decrease. As such, the set of UEs may perform respective cell selection procedures to establish a radio link with a second NTN entity or cell. Additionally, or alternatively, each of the set of UEs may continuously monitor a quality of service (QoS) associated with neighboring NTN cells of the NTN. As such, if a given UE determines that a second NTN cell may provide an increase in signal quality relative to the first NTN cell, the given UE may determine to perform a cell reselection procedure with the second NTN cell. However, as the quantity of UEs attempting cell selection or cell reselection increases, signaling overhead at the second NTN device may increase, resulting in an increase in latency and a decrease in user experience.

The wireless devices of the NTN may reduce signaling overhead and latency associated with cell selection and cell reselection by operating in accordance with the techniques described herein. For example, a current serving NTN cell may transmit to a set of UEs respective parameters associated with target NTN cells to use in the event of cell selection or cell reselection. For example, the serving NTN cell may transmit a broadcast signal that includes a respective master information block (MIB) and system information block 1 (SIB1) for each of a set of target NTN cells. As such, the set of UEs may perform a pre-validation and suitability check for a given cell prior to performing a cell selection or cell reselection procedure with the given cell. Such a pre-validation and suitability check may reduce the signaling between the set of UEs and a target NTN cell during link establishment.

In some examples, the serving NTN cell may explicitly indicate the MIB and SIB1 for a given target cell (e.g., a first string of bits indicating the MIB and a second string of bits indicating the SIB1). In some examples, the serving NTN cell may indicate delta MIB and SIB1 parameters for a given target cell that are relative to the MIB and SIB1 of the serving NTN cell. Using delta MIB and SIB1 parameters may reduce the signaling overhead of the broadcast signaling. In some examples, the serving NTN cell may include multiple sub-cell sectors that each correspond to a different geographic coverage area. As such, each sub-cell sector may correspond to a respective set of UEs serviced by the serving NTN cell. In some examples, the serving NTN cell may indicate respective target cells on a per sub-cell sector basis.

Aspects of the disclosure are initially described in the context of wireless communications systems, a cell sector configuration, and a process flow. Aspects of the disclosure are further illustrated by and described with reference to apparatus diagrams, system diagrams, and flowcharts that relate to mobility procedures for NTN devices.

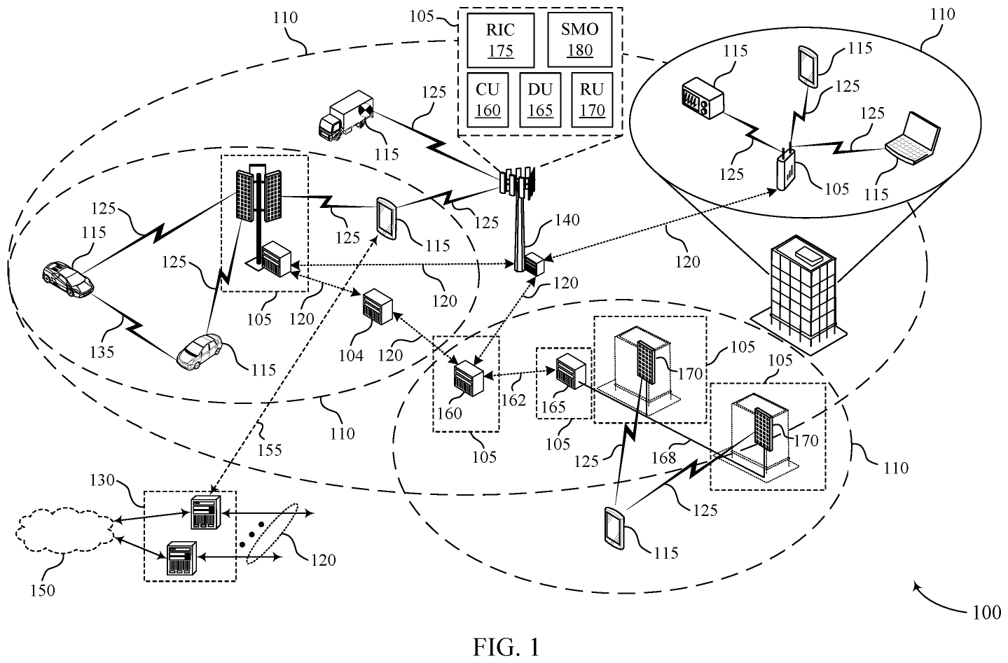

FIG. 1 shows an example of a wireless communications system 100 that supports mobility procedures for NTN devices in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support mobility procedures for NTN devices as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some examples of wireless communications system 100, one or more UEs 115 may communicate with an NTN that leverages NTN devices (e.g., satellites, high-altitude platforms (HAPs), and other aerial or space-based platforms) to provide connectivity and communication services. In some examples, a set of UEs 115 may be served by a first NTN cell of an NTN entity that may move relative to the set of UEs 115. In some examples, an NTN entity may be an example of a network entity 105, as described herein.

The wireless devices of the NTN may reduce signaling overhead and latency associated with cell selection and cell reselection by operating in accordance with the techniques described herein. For example, a current serving NTN cell may transmit to a set of UEs 115 respective parameters associated with target NTN cells to use in the event of cell selection or cell reselection. For example, the serving NTN cell may transmit a broadcast signal that includes a respective MIB and SIB1 for each of a set of target NTN cells. As such, the set of UEs 115 may perform a pre-validation and suitability check for a given cell prior to performing a cell selection or cell reselection procedure with the given cell. Such a pre-validation and suitability check may reduce the signaling between the set of UEs 115 and a target NTN cell during link establishment.

In some examples, the serving NTN cell may explicitly indicate the MIB and SIB1 for a given target cell (e.g., a first string of bits indicating the MIB and a second string of bits indicating the SIB1). In some examples, the serving NTN cell may indicate delta MIB and SIB1 parameters for a given target cell that are relative to the MIB and SIB1 of the serving NTN cell. Using delta MIB and SIB1 parameters may reduce the signaling overhead of the broadcast signaling. In some examples, the serving NTN cell may include multiple sub-cell sectors that each correspond to a different geographic coverage area. As such, each sub-cell sector may correspond to a respective set of UEs 115 serviced by the serving NTN cell. In some examples, the serving NTN cell may indicate respective target cells on a per sub-cell sector basis.

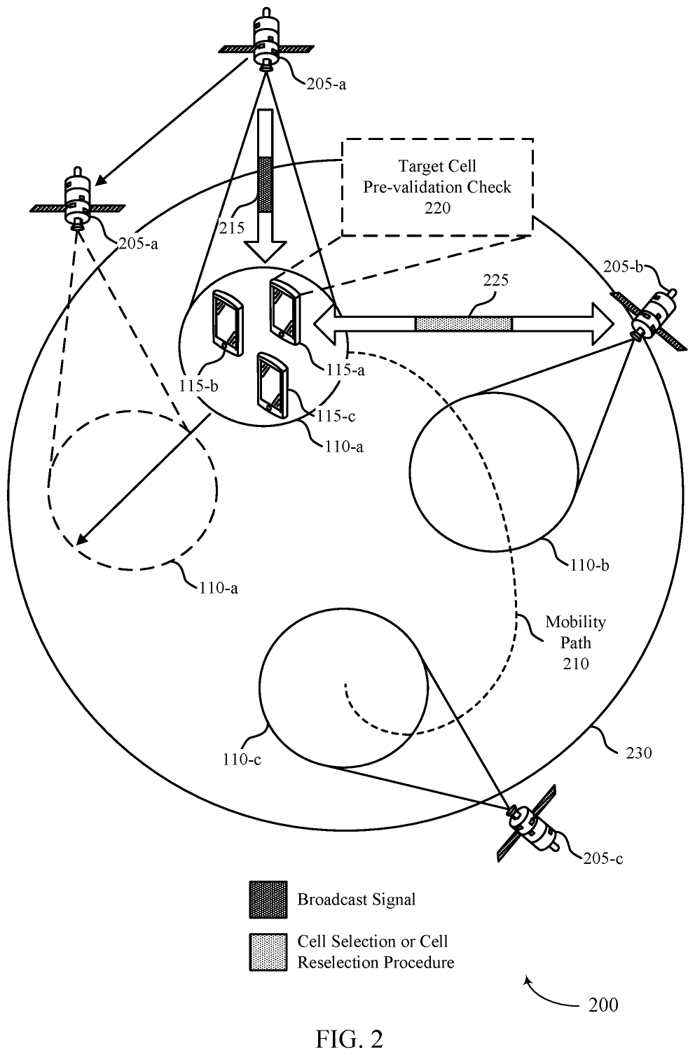

FIG. 2 shows an example of a wireless communications system 200 that supports mobility procedures for NTN devices in accordance with one or more aspects of the present disclosure. In some examples, the wireless communications system 200 may implement aspects of the wireless communications system 100. For example, the wireless communications system 200 may include a UE 115-a, a UE 115-b, and a UE 115-c, which may be examples of UEs 115, as described with reference to FIG. 1. Additionally, a cell 205-a, a cell 205-b, and a cell 205-c may be respective examples of network entities 105, or cells 205 associated with network entities 105, as described with reference to FIG. 1.

As illustrated in FIG. 2, the UEs 115 may reside on a terrestrial plane 230 (such as the Earth), and communicate with an NTN that leverages NTN devices (e.g., cell 205-a, 205-b, and 205-c) to provide connectivity and communication services. The NTN devices may include one or more of satellites (e.g., geosynchronous orbit (GSO), non-GSO (NGSO), low earth orbit (LEO), medium earth orbit (MEO), and geostationary equatorial orbit (GEO)), HAPs, and other aerial or space-based platforms. Additionally, each of the cells 205 may have an associated geographic coverage area 110 (e.g., geographic coverage area 110-a, 110-b, and 110-c respectively associated with cell 205-a, 205-b, and 205-c). As such, wireless devices within a given geographic coverage area 110 may be serviced by the associated cell 205. For example, cell 205-a may service the UE 115-a, 115-b, and 115-c based on the UEs 115 residing within geographic coverage area 110-a. In some examples, each cell 205 may be associated with a respective beam, frequency bandwidth, or both to communicate with wireless devices. Additionally, or alternatively, while the cells 205 are illustrated as separate NTN devices, it is understood that the one or more cells 205 may be associated with a same NTN device (e.g., an NTN entity), separate NTN devices (e.g., multiple NTN entities), or a combination thereof. As such, a given NTN may be associated with any quantity of cells 205 that are each associated with a respective geographic coverage area 110, a respective beam, and a respective frequency.

Based on the cells 205 residing in a non-terrestrial plane (such as in the atmosphere of Earth), the cells 205 may follow a mobility path 210 relative to the terrestrial plane 230. That is, the cells 205 may move relative to UEs 115 that are stationary on the terrestrial plane 230. For example, as illustrated in FIG. 2, the cell 205-a and the geographic coverage area 110-a may move out of service coverage for the UEs 115, and a second cell 205 (e.g., the cell 205-b) may move into service coverage of the UEs 115. In some examples, the service coverage of cell 205-a may be available for a duration (e.g., t_service duration), such that once the duration expires (e.g., stop_time) the UEs 115 may perform a cell selection or cell reselection procedure to the second cell 205. In some examples, the cell 205-a may indicate the t_service duration via system information (SI), control signaling (e.g., RRC, MAC control element (MAC-CE), or downlink control information (DCI)), or a combination thereof.

In some examples, a UE 115 may perform cell selection if a cell 205 initially enters a cellular network or when searching for a second cell 205. The UE 115 may determine to search for a second cell 205 to connect to due to one or more factors such as powering up (e.g., transitioning from a transceiver off-state to a transceiver on-state), loss of signal with a current serving cell 205, or a deliberate search for a cell 205 with a higher service quality. As such, a UE 115 may perform a cell selection procedure is to increase the QoS provided to the UE 115 and to increase performance at the UE 115.

In some examples, a UE 115 may perform cell reselection when the UE 115 is connected to a serving cell 205 and evaluates other target cells 205 to determine if a target cell 205 may provide an increase in signal quality relative to the serving cell 205. The cell 205 reselection process may be continuous and automatic. For instance, while connected to the serving cell 205, the UE 115 may continuously monitor the signal quality and other relevant parameters of target cells 205. In some examples, the UE 115 may be predefined with thresholds for parameters (such as signal strength, signal quality, and load conditions). As such, if the measured parameters of a target cell 205 satisfy the predefined thresholds and are better than the current serving cell 205, the UE 115 may trigger cell reselection. If the UE 115 determines that a target cell 205 satisfies the criteria for cell reselection, the UE 115 may start preparing for a handover. In some examples, handover may involve transitioning the connection from the current cell 205 to the selected neighboring cell 205 while refraining from interrupting the ongoing communication.

Based on the mobility path 210 of the cells 205, the associated NTN may configure target cell 205 configuration in connected mode using a conditional handover (CHO) configuration (e.g., location based handover, time based handover, or both). For example, a time based CHO triggering condition may include a time interval (e.g., condEvent T1) during which a given UE 115 may execute CHO to a corresponding CHO candidate cell 205. A location based CHO triggering condition may include a distance parameter (e.g., condEvent D1) such that if the distance between a given UE 115 and a current serving cell 205 is greater than a first threshold and the distance between the given UE 115 and a candidate cell 205 is less than a second threshold, then the given UE 115 may execute CHO to the corresponding CHO candidate cell 205. Such techniques of cell 205 based CHO may enable the NTN to configure cell reselection or CHO configuration in accordance with cell 205 ephemeris information. Based on ephemeris information of a cell 205, a given UE 115 may proactively move between cells 205 which may increase NTN service time. In some cases, a longer NTN service time may decrease UE 115 mobility procedure which may reduce propagation delays between the UE 115 and the NTN and further reduce power consumption at the UE 115.

Based on the relative location of the UE 115-a, 115-b, and 115-c, each of the UEs 115 may independently identify a CHO triggering condition (e.g., condEvent T1, condEvent D1, or both) based on the cell 205-a moving along the mobility path 210. As such, on or more of the UEs 115 serviced by the cell 205-a may concurrently perform a respective CHO procedure to a second cell 205. However, as the quantity of UEs 115 attempting concurrent mobility increases, signaling overhead and load at the second cell 205 may increase. In some cases, an increase in signal load may result in radio link failure (RLF) between a given UE 115 and the second cell 205, and a resulting RLF recovery procedure may increase power consumption, signaling, and latency between the second cell 205 and the given UE 115.

The UEs 115 of the NTN may reduce signaling overhead and latency associated with cell selection and cell reselection by operating in accordance with a target cell pre-validation check 220. For example, a given cell 205 may be associated with a set of cell 205 parameters corresponding to a MIB and SIB1 of the given cell 205. These parameters may include one or more of a cell frequency, tracking area code (TAC), public land mobile network (PLMN) ID, a signal strength threshold for handover (e.g., Qrxlev_min), among other parameters. In some examples, cells 205 neighboring a serving cell 205 may be associated with a respective MIB and SIB1 that includes parameters that are common, or close in proximity to the parameters of the serving cell 205. As such, the serving cell 205-a may transmit a broadcast signal 215, which may indicate a respective MIB and SIB1 for each of a set of target cells 205, to use in the event of a CHO procedure, cell selection, or cell reselection.

In one example, the cell 205-a may transmit the broadcast signal 215 which may indicate a first MIB and SIB1 associated with cell 205-b and a second MIB and SIB1 associated with cell 205-c. Based on receiving a respective MIB and SIB1 for each of cells 205-b and 205-c, the UEs 115 may validate which of cells 205-b and 205-c may serve as potential candidate cells 205 in the event of a CHO procedure (e.g., the target cell per-validation check 220). For instance, using the first MIB and SIB1 associated with cell 205-b, the UE 115-a may determine whether the cell 205-b satisfies one or more cell suitability criteria.

In some examples of the cell suitability criteria, the UE 115 may use the frequency included in the first MIB and SIB1 to measure a quality of a potential link between the UE 115 and the cell 205-b (e.g., a reference signal receive power (RSRP), or a reference signal receive quality (RSRQ)). Additionally, or alternatively, the UE 115 may use the signal strength threshold for handover (e.g., Qrxlev_min) included in the first MIB and SIB1 to identify whether the quality of the potential link is satisfactory to perform a cell reselection with the cell 205-b.

In some examples of the cell suitability criteria, the UE 115 may determine a cell load of the cell 205-b. For instance, the cell load may refer to the quantity of wireless devices connected or serviced by a given cell 205. As such, if the cell 205-b has a cell load less than a cell load of the cell 205-a, the UE 115 may determine the cell 205-b as a candidate for cell reselection.

In some examples of the cell suitability criteria, the UE 115 may determine the physical cell identity (PCI) or cell identity (CID) of the cell 205-b. If the cell 205-b has a different PCI or CID compared to the cell 205-a, the cell 205-b may correspond to a network sector associated with less data, higher performance, or both. As such, the UE 115 may determine cell 205-b as a candidate for cell reselection based on the PCI or CID of the cell 205-b.

In some examples of the cell suitability criteria, the UE 115 may determine QoS parameters associated with the cell 205-b. For instance, parameters related to QoS may indicate data rates and latency conditions associated with the cell 205-b. As such, the UE 115 may determine cell 205-b as a candidate for cell reselection based on the QoS parameters associated with the cell 205-b.

In some examples of the cell suitability criteria, the UE 115 may determine a SNR associated with the cell 205-b. For instance, if the UE 115 measures that the SNR of cell 205-b is greater than the SNR of cell 205-a, the UE 115 may determine cell 205-b as a candidate for cell reselection.

In some examples of the cell suitability criteria, the UE 115 determine a frequency band associated with the cell 205-b. For instance, different frequency bands may be associated with different propagation characteristics. As such, if the cell 205-b is associated with a frequency band that provides an increase in signal conditions relative to the cell 205-a, the UE 115 may determine cell 205-b as a candidate for cell reselection.

In some examples of the cell suitability criteria, the UE 115 determine the PLMN and TAC of the cell 205-b. For instance, if the UE 115 determines that the PLMN and TAC of the cell 205-b satisfy network and tracking area parameters defined at the UE 115, the UE 115 may determine cell 205-b as a candidate for cell reselection.

In some examples of the cell suitability criteria, the UE 115 determine a status of the cell 205-b. In some examples, the cell 205-b may be associated with a barred status, which indicates that the cell 205-b is inaccessible or barred for specific devices. In some examples, the cell 205-b may be associated with a reserved status, which indicates that the cell 205-b is reserved for emergency services or high-priority users. As such, the UE 115 may determine the cell 205-b as a candidate for cell reselection if the cell 205-b is not associated with a barred status or a reserved status.

As such, the UE 115 may use the cell suitability criteria to pre-validate the cell 205-b as a candidate cell 205 for a CHO procedure, and store the first MIB and SIB1 at a memory of the UE 115. The UE 115 may perform the target cell per-validation check 220 for each of the target cells 205 indicated in the broadcast signal 215.

As illustrated in FIG. 2, the UE 115-a may determine the cell 205-b as a candidate cell 205 for cell selection or cell resection, and in the event of a CHO triggering condition, may perform a cell selection or cell reselection procedure 225 with the cell 205-b. Based on performing the target cell per-validation check 220, the UE 115-a may use the first MIB and SIB1 stored in memory rather than decoding the MIB and SIB1 broadcasted by the cell 205-b, which may reduce latency associated with performing the cell selection or cell reselection procedure 225. In some examples, each of the UEs 115 may perform a respective target cell pre-validation check 220, which may reduce the signaling associated with performing a respective cell selection or cell reselection with the cell 205-b, reducing the occurrence of RLF between the cell 205-b and each of the UEs 115.

Based on the mobility path 210 being pre-defined, the cell 205-a may determine the which cells 205 may provide a signal quality for the UEs 115 above a threshold, and select those cells 205 as the target cells 205 to indicate in the broadcast signal 215. In some examples, the information for the target cells 205 (e.g., MIB and SIB1) may be included in SIB19 (e.g., for 5G-NR), included in SIB32 (e.g., for LTE), or both. In accordance with idle mode, the UE 115 may use the MIB and SIB1 information included in the SIB19, the SIB32 for an increase in mobility.

In some examples, the serving cell 205-a may indicate the MIB and SIB1 for each target cell explicitly. For instance, the SIB19 or SIB32 may include a target cell signaling configuration parameter (e.g., ntn-NeighSignalingConfig-vXX) that includes a first string of bits that indicates a MIB for a target cell 205 (e.g., neighMib) and a second string of bits that indicates the SIB1 for the target cell 205 (e.g., neighSIB1). In some examples, the first and second string of bits may be a length of eight (e.g., a string octet); however, the serving cell 205-a may indicate the MIB and SIB1 of a given target cell 205 using any quantity of bits.

In some examples, the serving cell 205-a may indicate a MIB and SIB1 of a target cell relative to the MIB and SIB1 of the serving cell 205-a. For example, the broadcast signal 215 may indicate a set of delta MIB parameters relative to the MIB of the serving cell 205-a and a set of delta SIB1 parameters relative to the SIB1 of the serving cell 205-a. I

In some examples, a given delta parameter set may refrain from indicating parameters that are the same between the serving cell 205-a and a given target cell 205. In one example, the cell 205-a and the cell 205-b may share each of the same SIB1 parameters except for the parameter Qrxlev_min, where cell 205-a has a first Qrxlev_min value and cell 205-b has a second Qrxlev_min value. In such an example, the broadcast signal 215 may include a delta parameter set for cell 205-b that indicates the second Qrxlev_min value. As such, the UE 115 may determine the SIB1 for cell 205-b by using the second Qrxlev_min value and using the other SIB1 parameters configured for the cell 205-a.

In some cases, the given delta parameter may be explicitly indicated. For instance, if the Qrxlev_min value of cell 205-a is a value of −80 dBm and the Qrxlev_min value of cell 205-b is a value of −90 dBm, the delta parameter set for cell 205-b may indicate that the Qrxlev_min value of cell 205-b is −90 dBm. In some other cases, the given delta parameter may be indicated relative to the parameter of the serving cell 205-a. For instance, if the Qrxlev_min value of cell 205-a is a value of −80 dBm and the Qrxlev_min value of cell 205-b is a value of −90 dBm, the delta parameter set for cell 205-b may indicate that the Qrxlev_min value of cell 205-b is 10 dBm less than the Qrxlev_min value of cell 205-a (e.g., −90 dBm).

By using delta parameters, the cell 205-a may reduce the quantity of data included in the broadcast signal 215, which may reduce signaling overhead for the wireless communications system 200.

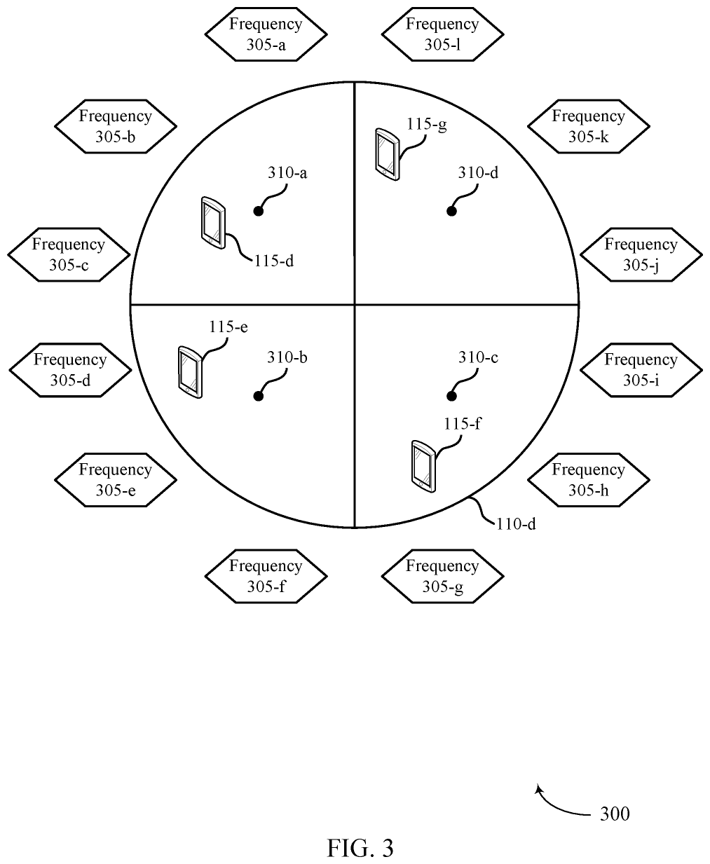

In some cases, the serving cell 205-a may be divided into multiple sectors, where each sector of the cell 205-a may correspond to a respective reference location relative to the terrestrial plane 230. In some examples, the serving cell 205 may configure respective broadcast signals 215 for each of the multiple sectors that indicates respective target cell 205 MIB and SIB1 information. Further discission of techniques associated with cell 205 sectoring is described herein, including with reference to FIG. 3.

FIG. 3 shows an example of a cell sector configuration 300 that supports mobility procedures for NTN devices in accordance with one or more aspects of the present disclosure. In some examples, the cell sector configuration 300 may implement aspects of the wireless communications system 100 and 200. For example, UE 115-d, 115-e, 115-f, and 115-g may be examples of UEs 115 as described with reference to FIGS. 1 and 2. Additionally, the cell sector configuration 300 may include a geographic coverage area 110-d, which may be associated with a service area of a current serving cell. As such, a cell may service each of the UEs 115 described herein.

As illustrated in FIG. 3, the geographic coverage area 110-d may be divided into a set of cell sectors, where each cell sector corresponds to a reference location 310. In some cases, each reference location 310 may be associated with a location in the geographic coverage area 110-d. As such, each UE 115 may be associated with a respective cell sector based on a proximity of a UE to a given reference location 310. For example, the UE 115-d may be associated with a first cell sector corresponding reference location 310-a, the UE 115-e may be associated with a second cell sector corresponding reference location 310-b, the UE 115-f may be associated with a third cell sector corresponding reference location 310-c, and the UE 115-g may be associated with a fourth cell sector corresponding reference location 310-d. While FIG. 3 illustrates a cell divided into four cell sectors, it is understood that a given cell may configure any quantity of cell sectors that correspond to respective reference locations 310.

As illustrated in FIG. 3, each reference location 310 may be associated with respective frequencies 305. For example, reference location 310-a may be associated with frequency 305-a, 305-b, and 305-c, reference location 310-b may be associated with frequency 305-d, 305-e, and 305-f, reference location 310-c may be associated with frequency 305-g, 305-h, and 305-i, and reference location 310-a may be associated with frequency 305-j, 305-k, and 305-l. In some cases, each frequency 305 may correspond to a respective cell that neighbors the serving cell associated with geographic coverage area 110-d. That is each cell sector may be associated with a respective set of neighboring cells 205. While FIG. 3 illustrates each frequency 305 corresponding to a single reference location 310, it is understood that a given frequency 305 and the associated cell may correspond to multiple reference locations 310 of the cell sector configuration 300.

In some examples, each cell sector may be associated with a respective RRC reconfiguration. That is, UEs 115 corresponding to respective reference locations 310 may receive respective RRC reconfiguration messages. Additionally, or alternatively, each reference location 310 may be configured with a respective CHO configuration corresponding to the respective frequencies 305 associated with the respective reference location 310. That is, the UE 115-d may receive a CHO configuration message that is associated with the cells 205 corresponding to frequency 305-a, 305-b, and 305-c. In accordance with the techniques of FIG. 2, a respective CHO configuration message may indicate respective parameters associated with the cells corresponding the frequency 305-a, 305-b, and 305-c. For example, the UE 115-d may receive a CHO configuration message that indicates respective MIB and SIB1 associated with each cell corresponding to frequency 305-a, 305-b, and 305-c. As such, the MIB and SIB1 of target cells 205 indicated to a given UE 115 for potential CHO may be based on which reference location 310 the given UE 115 is associated with. The serving cell may determine which reference location 310 a UE 115 is associated with based on the TAC of the UE. As such, the serving cell may group UEs 115 based on the reference location 310 and transmit each group of UEs 115 a respective CHO configuration corresponding to the reference location 310. In some examples, configuring respective CHO configuration messages on a per cell sector basis may reduce signaling load for the serving cell and the UEs 115.

In some cases, one or more of the UEs 115 may move relative to the terrestrial plane. Additionally, the current serving cell may be associated with multiple neighboring cells. As such, to perform mobility, a given UE 115 may measure the frequency 305 associated with each of the neighbor cells to determine a signal quality associated with each frequency 305 (e.g., an RSRP value, an RSRQ value, among other quality value types). In some examples, the given UE 115 may and perform an idle mode or connected mode mobility procedure if a frequency 305 is associated with a signal quality above a threshold (e.g., frequency 305>RSRP_Thresh).

In some examples, the current serving cell may transmit reference signal parameters associated with the set of target cells corresponding to a given sector. For example, the UE 115-d may receive reference signal parameters for the target cells associated with frequency 305-a, 305-b, and 305-c. In some cases, the UE 115-a may prioritize the target cells for mobility in accordance with a prioritization procedure. For example, if the UE 115-a is located at a first coordinate (e.g., x, y, z), the UE may search for neighbor cells within a range of the first coordinate (e.g., x+ range x1, y+ range yl, z+ range z1). If an NTN frequency is identified and the UE 115-a measures a signal quality that satisfies a threshold (e.g., RSRP>RSRP_Thresh), then the UE may consider the cell associated with the identified frequency as a candidate cell for cell reselection and handover. As such, the UE may perform mobility with the candidate cell.

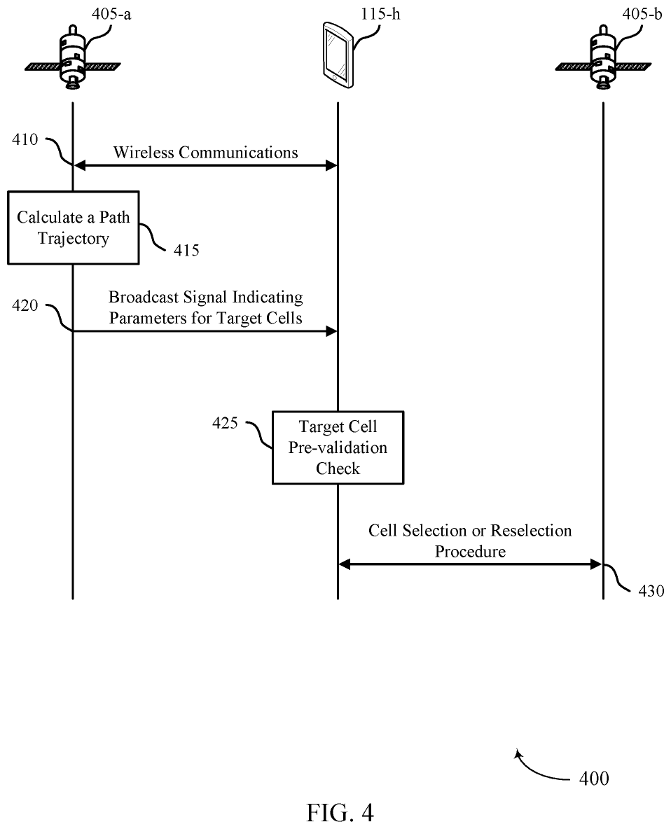

FIG. 4 shows an example of a process flow 400 that supports mobility procedures for NTN devices in accordance with one or more aspects of the present disclosure. In some examples, process flow 400 may implement aspects of wireless communications system 100 and 200 and cell sector configuration 300. Process flow 400 includes a UE 115-h, a cell 405-a, and a cell 405-b, as described with reference to FIGS. 1 through 3. Alternative examples of the following may be implemented, where some steps are performed in a different order than described or are not performed at all. In some cases, steps may include additional features not mentioned below, or further steps may be added. In addition, while process flow 400 shows processes between a single UE 115 and two cells 405, it should be understood that these processes may occur between any quantity of network devices and network device types. Additionally, each of the cells 405 may be associated with a same NTN entity, different NTN entities, or a combination thereof.

At 410, the UE 115-h may communicate with the cell 405-a. For example, the cell 405-a may be an example of a serving cell, providing access between the NTN and the UE 115-h. In some examples, the UE 115-h and the cell 405-a may communicate based on the UE 115-h residing within a geographic coverage area of the cell 405-a. In some examples, the cell 405-a may serve multiple UEs 115 or other wireless devices within the geographic coverage area associated with the cell 405-a.

At 415, the cell 405-a may calculate a trajectory of the cell 405-a with respect to the UEs 115 served by the cell 405-a. In some examples, trajectory of the cell 405-a may be based on ephemeris information associated with the NTN entity that includes the cell 405-a. Additionally, or alternatively, the cell 405-a may determine the trajectory of one or more other cells 405 of the NTN (e.g., the cell 405-b, among other neighboring cell 405). For instance, the cells 405 of the NTN may exchange respective ephemeris information. In some examples, one or more cells 405 may be included on the same NTN entity as the cell 405-a, and the cell 405-a may determine the ephemeris information of each of the one or more cells 405 via internal NTN entity mechanisms. In some examples, one or more cells 405 may be included on a second NTN entity different from the NTN entity of the cell 405-a, and as such the cell 405-a may receive one or more signals to determine the ephemeris information of the one or more cells 405 (e.g., via respective SI messages, or other types of control messaging).

At 420, the UE 115-h may receive a broadcast signal indicating respective parameters associated with the cell 405-a and one or more target cells 405 of the NTN that are different from the cell 405-a (e.g., including the cell 405-b).

In some examples, the respective parameters may be associated with cell selection or cell reselection from the cell 405-a to a target cell 405 of the one or more target cells 405. For instance, the respective parameters may indicate a respective MIB and a respective SIB1 for each target cell 405 of the one or more target cells 405. In some examples, the respective MIB for a given target cell 405 may be indicated via a first string of bits and the respective SIB1 for the given target cell 405 may be indicated via a second string of bits. Additionally, or alternatively, the respective MIB for a given target cell 405 may be indicated via a set of delta MIB parameters relative to a first MIB of the cell 405-a, and the respective SIB1 for the given target cell 405 is indicated via a set of delta SIB1 parameters relative to a first SIB1 of the cell 405-a. For example, the set of delta SIB1 parameters may include one or more of a frequency, a TAC, a PLMN identifier, and a signal strength threshold for cell selection or cell reselection.

In some cases, the cell 405-a may include a set of sub-cell sections each associated with a respective geographic coverage area (e.g., as described with reference to FIG. 3). As such, a geographic location of the UE 115-h may be within the respective geographic coverage area of a first sub-cell section of the set of sub-cell sections. In some examples, the one or more target cells 405 associated with the broadcast signal and the respective parameters associated with the one or more target cells 405 may be based on the geographic location of the UE 115-h being within the respective geographic coverage area of the first sub-cell section.

At 425, the UE 115-h may perform a target cell pre-validation check for each target cell 405 of the one or more target cells 405 indicated in the broadcast signal. In some examples, the UE 115-h may store the respective parameters associated with the one or more target cells 405 of the NTN. In accordance with the target cell pre-validation check, the UE 115-h may determine the cell 405-b as a candidate cell for cell selection using the stored respective parameters associated with the cell 405-b. For instance, the UE 115-h may determine a first frequency associated with the cell 405-b using the stored respective parameters associated with the cell 405-b (e.g., the MIB and SIB1 of the cell 405-b). In some examples, the UE 115-h may measure, via the first frequency associated with the cell 405-b, one or more cell suitability criteria, where determining the cell 405-b as the candidate cell for cell selection or cell reselection may be based on the cell 405-b satisfying the one or more cell suitability criteria. The one or more cell suitability criteria may include one or more of an RSRP value of the cell 405-b, an RSRQ value of the cell 405-b, a cell load of the cell 405-b, a cell identifier of the cell 405-b, one or more QoS parameters of the cell 405-b, an SNR value of the cell 405-b, the first frequency of the cell 405-b, a coverage area overlap between the cell 405-b and the cell 405-a, a PLMN or TAC of the cell 405-b, or a status of the cell 405-b.

At 430, the UE 115-h may perform a cell selection procedure or a cell reselection procedure with the cell 405-b using the stored respective parameters associated with the cell 405-b. For example, the UE 115-h may identify a radio link failure for a first radio link between the UE 115-h and the cell 405-a and establish a second radio link between the UE 115-h and the cell 405-b using the stored respective parameters associated with the cell 405-b. Additionally, or alternatively, the UE 115-h may determine that the cell 405-b may provide increased performance with the NTN compared to the cell 405-a, based on the one or more cell suitability criteria of the cell 405-b. As such, the UE 115-h may perform a cell reselection procedure with the cell 405-b.

In some examples, the UE 115-h may move relative to the terrestrial plane. In such examples, the UE 115-h may perform a handover procedure by measuring, via a respective frequency associated with each target cell 405 of the one or more target cells 405 within a range of a geographic location of the UE 115-h, a respective RSRP value. In some examples, the UE 115-h may determine one or more candidate cells 405 for handover from the one or more target cells 405, where each candidate cell 405 of the one or more candidate cells 405 has a respective RSRP value that satisfies a threshold. As such, the UE 115-h may perform the cell selection or reselection procedure with the cell 405-b based on determining the cell 405-b as a candidate cell.

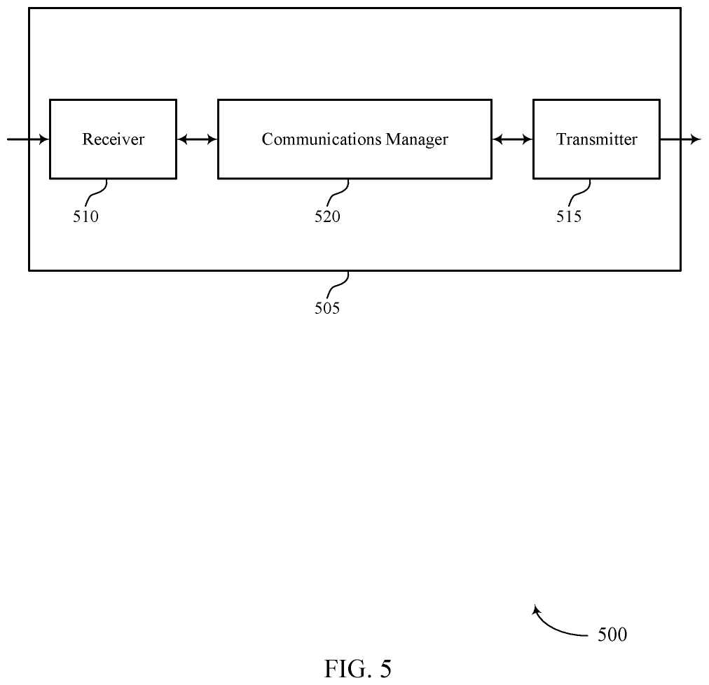

FIG. 5 shows a block diagram 500 of a device 505 that supports mobility procedures for NTN devices in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, and the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to mobility procedures for NTN devices). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to mobility procedures for NTN devices). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of mobility procedures for NTN devices as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor. If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving, from a first cell of an NTN, a broadcast signal indicating respective parameters associated with the first cell and one or more target cells of the NTN that are different from the first cell, the respective parameters associated with cell selection or cell reselection. The communications manager 520 is capable of, configured to, or operable to support a means for storing the respective parameters associated with the one or more target cells of the NTN. The communications manager 520 is capable of, configured to, or operable to support a means for performing a cell selection procedure or a cell reselection procedure with a first target cell of the one or more target cells of the NTN using stored respective parameters associated with the first target cell.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced processing, reduced latency, reduced power consumption, and a more efficient utilization of communication resources.

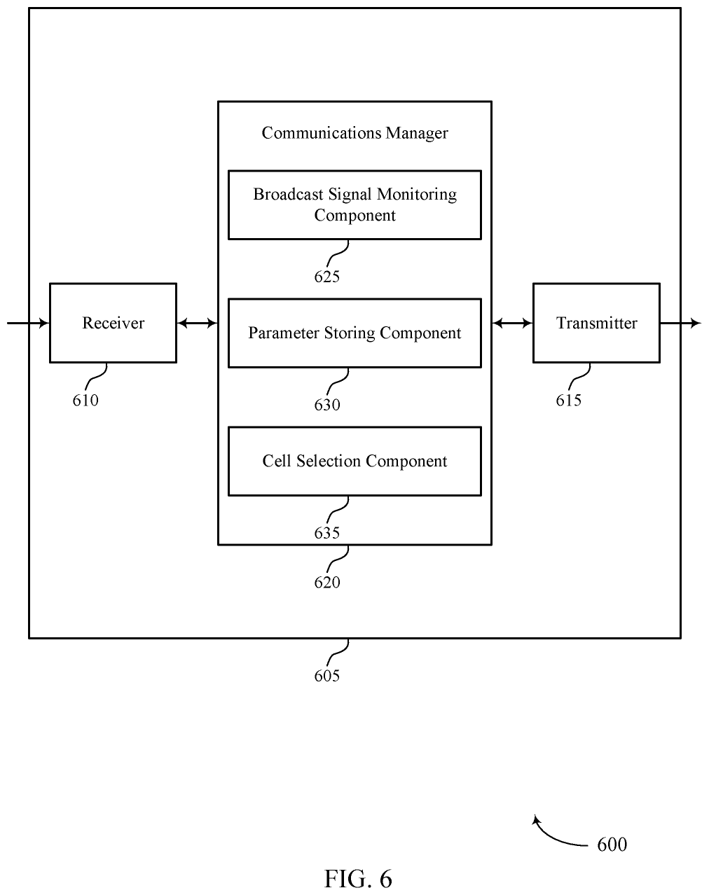

FIG. 6 shows a block diagram 600 of a device 605 that supports mobility procedures for NTN devices in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, and the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to mobility procedures for NTN devices). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to mobility procedures for NTN devices). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of mobility procedures for NTN devices as described herein. For example, the communications manager 620 may include a broadcast signal monitoring component 625, a parameter storing component 630, a cell selection component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The broadcast signal monitoring component 625 is capable of, configured to, or operable to support a means for receiving, from a first cell of an NTN, a broadcast signal indicating respective parameters associated with the first cell and one or more target cells of the NTN that are different from the first cell, the respective parameters associated with cell selection or cell reselection. The parameter storing component 630 is capable of, configured to, or operable to support a means for storing the respective parameters associated with the one or more target cells of the NTN. The cell selection component 635 is capable of, configured to, or operable to support a means for performing a cell selection procedure or a cell reselection procedure with a first target cell of the one or more target cells of the NTN using stored respective parameters associated with the first target cell.

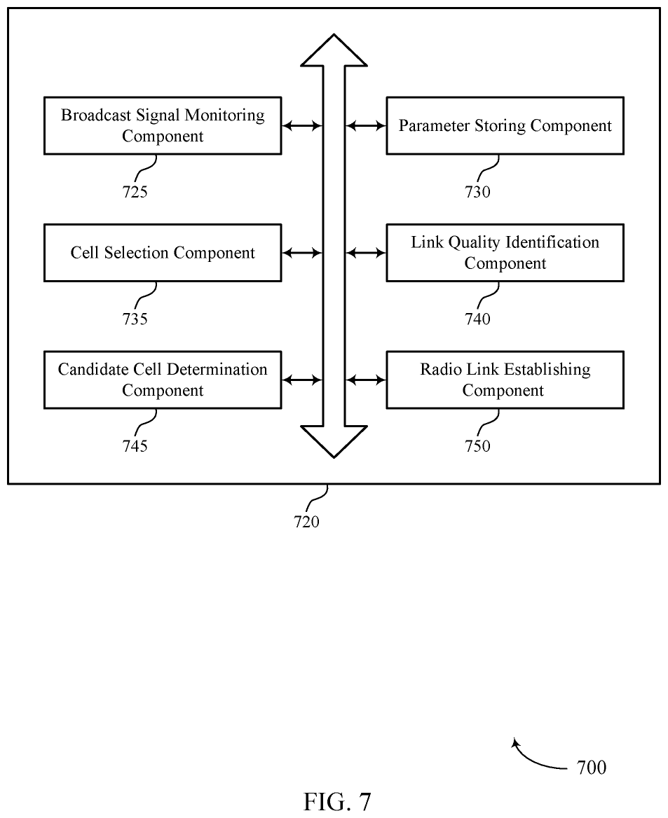

FIG. 7 shows a block diagram 700 of a communications manager 720 that supports mobility procedures for NTN devices in accordance with one or more aspects of the present disclosure. The communications manager 720 may be an example of aspects of a communications manager 520, a communications manager 620, or both, as described herein. The communications manager 720, or various components thereof, may be an example of means for performing various aspects of mobility procedures for NTN devices as described herein. For example, the communications manager 720 may include a broadcast signal monitoring component 725, a parameter storing component 730, a cell selection component 735, a link quality identification component 740, a candidate cell determination component 745, a radio link establishing component 750, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The broadcast signal monitoring component 725 is capable of, configured to, or operable to support a means for receiving, from a first cell of an NTN, a broadcast signal indicating respective parameters associated with the first cell and one or more target cells of the NTN that are different from the first cell, the respective parameters associated with cell selection or cell reselection. The parameter storing component 730 is capable of, configured to, or operable to support a means for storing the respective parameters associated with the one or more target cells of the NTN. The cell selection component 735 is capable of, configured to, or operable to support a means for performing a cell selection procedure or a cell reselection procedure with a first target cell of the one or more target cells of the NTN using stored respective parameters associated with the first target cell.

In some examples, to support performing the cell selection procedure or the cell reselection procedure, the link quality identification component 740 is capable of, configured to, or operable to support a means for identifying a radio link failure for a first radio link between the UE and the first cell. In some examples, to support performing the cell selection procedure or the cell reselection procedure, the candidate cell determination component 745 is capable of, configured to, or operable to support a means for determining the first target cell as a candidate cell for cell selection using the stored respective parameters associated with the first target cell. In some examples, to support performing the cell selection procedure or the cell reselection procedure, the radio link establishing component 750 is capable of, configured to, or operable to support a means for establishing a second radio link between the UE and the first target cell using the stored respective parameters associated with the first target cell.

In some examples, the candidate cell determination component 745 is capable of, configured to, or operable to support a means for determining a first frequency associated with the first target cell using the stored respective parameters associated with the first target cell. In some examples, the candidate cell determination component 745 is capable of, configured to, or operable to support a means for measuring, via the first frequency associated with the first target cell, one or more cell suitability criteria, where determining the first target cell as the candidate cell for cell selection or cell reselection is based on the first target cell satisfying the one or more cell suitability criteria.

In some examples, the one or more cell suitability criteria includes one or more of a RSRP value of the first target cell, a RSRQ value of the first target cell, a cell load of the first target cell, a cell identifier of the first target cell, QoS parameters of the first target cell, a SNR value of the first target cell, the first frequency of the first target cell, a coverage area overlap between the first target cell and the first cell, a PLMN or TAC of the first target cell, or a status of the first target cell.

In some examples, the respective parameters indicate a MIB and a respective SIB1 for each target cell of the one or more target cells.

In some examples, the respective MIB for a given target cell is indicated via a first string of bits and the respective SIB1 for the given target cell is indicated via a second string of bits.

In some examples, the respective MIB for a given target cell is indicated via a set of delta MIB parameters relative to a first MIB of the first cell, and the respective SIB1 for the given target cell is indicated via a set of delta SIB1 parameters relative to a first SIB1 of the first cell.

In some examples, the set of delta SIB1 parameters include one or more of a frequency, a TAC, a PLMN identifier, and a signal strength threshold for cell selection or cell reselection.

In some examples, the first cell includes a set of sub-cell sections each associated with a respective geographic coverage area. In some examples, a geographic location of the UE is within the respective geographic coverage area of a first sub-cell section of the set of sub-cell sections.

In some examples, the one or more target cells associated with the broadcast signal and the respective parameters associated with the one or more target cells are based on the geographic location of the UE being with the respective geographic coverage area of the first sub-cell section.

In some examples, to support UE is moving relative to a terrestrial plane, performing a handover procedure, the candidate cell determination component 745 is capable of, configured to, or operable to support a means for measuring, via a respective frequency associated with each target cell of the one or more target cells within a range of a geographic location of the UE, a respective RSRP value. In some examples, to support UE is moving relative to a terrestrial plane, performing a handover procedure, the candidate cell determination component 745 is capable of, configured to, or operable to support a means for determining one or more candidate cells for handover from the one or more target cells, where each candidate cell of the one or more candidate cells has a respective RSRP value that satisfies a threshold.

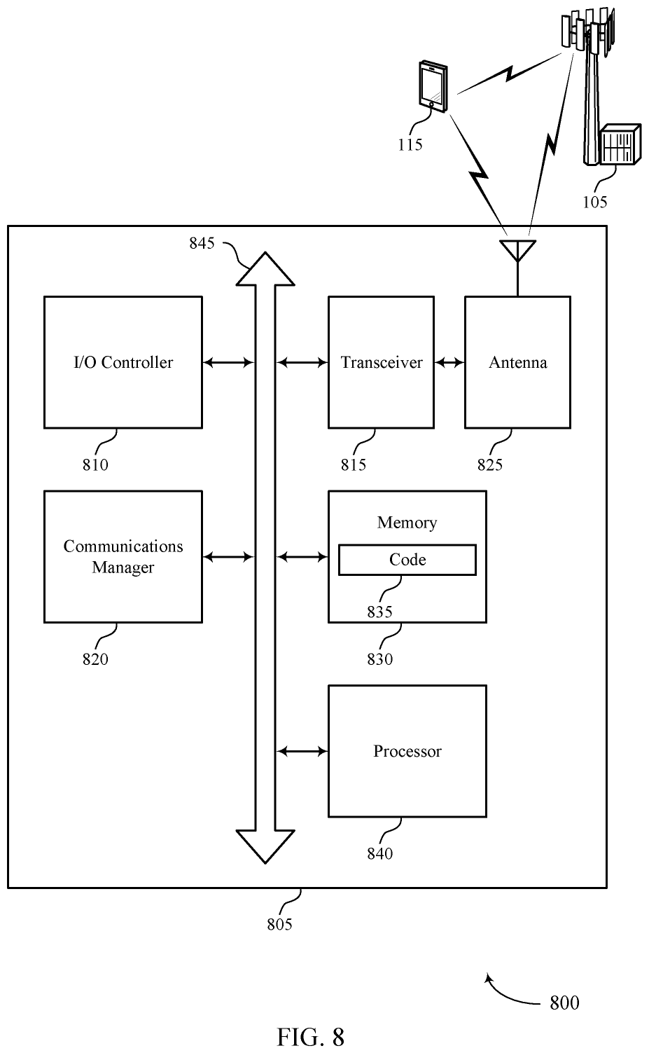

FIG. 8 shows a diagram of a system 800 including a device 805 that supports mobility procedures for NTN devices in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable code 835 including instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may contain, among other things, a basic I/O system (BIOS) which may control basic hardware or software operation such as the interaction with peripheral components or devices.

The at least one processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting mobility procedures for NTN devices). For example, the device 805 or a component of the device 805 may include at least one processor 840 and at least one memory 830 coupled with or to the at least one processor 840, the at least one processor 840 and at least one memory 830 configured to perform various functions described herein. In some examples, the at least one processor 840 may include multiple processors and the at least one memory 830 may include multiple memories. One or more of the multiple processors may be coupled with one or more of the multiple memories, which may, individually or collectively, be configured to perform various functions herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. As such, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving, from a first cell of an NTN, a broadcast signal indicating respective parameters associated with the first cell and one or more target cells of the NTN that are different from the first cell, the respective parameters associated with cell selection or cell reselection. The communications manager 820 is capable of, configured to, or operable to support a means for storing the respective parameters associated with the one or more target cells of the NTN. The communications manager 820 is capable of, configured to, or operable to support a means for performing a cell selection procedure or a cell reselection procedure with a first target cell of the one or more target cells of the NTN using stored respective parameters associated with the first target cell.

By including or configuring the communications manager 820 in accordance with examples as described herein, the device 805 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of mobility procedures for NTN devices as described herein, or the at least one processor 840 and the at least one memory 830 may be otherwise configured to, individually or collectively, perform or support such operations.

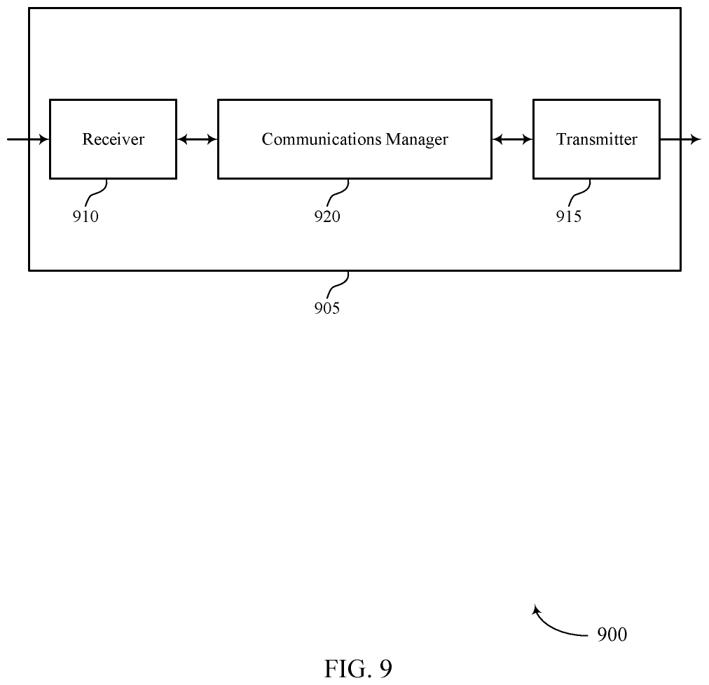

FIG. 9 shows a block diagram 900 of a device 905 that supports mobility procedures for NTN devices in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, and the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of mobility procedures for NTN devices as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor. If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for calculating a trajectory of the first cell with respect to a set of multiple UEs served by the first cell, the trajectory of the first cell based on ephemeris information associated with the NTN entity. The communications manager 920 is capable of, configured to, or operable to support a means for transmitting, a broadcast signal from the first cell indicating respective parameters associated with one or more target cells of the NTN, the respective parameters associated with a cell selection or cell reselection from the first cell, where the one or more target cells and the respective parameters are based on the ephemeris information associated with the NTN entity.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for reduced processing, reduced latency, reduced power consumption, and a more efficient utilization of communication resources.

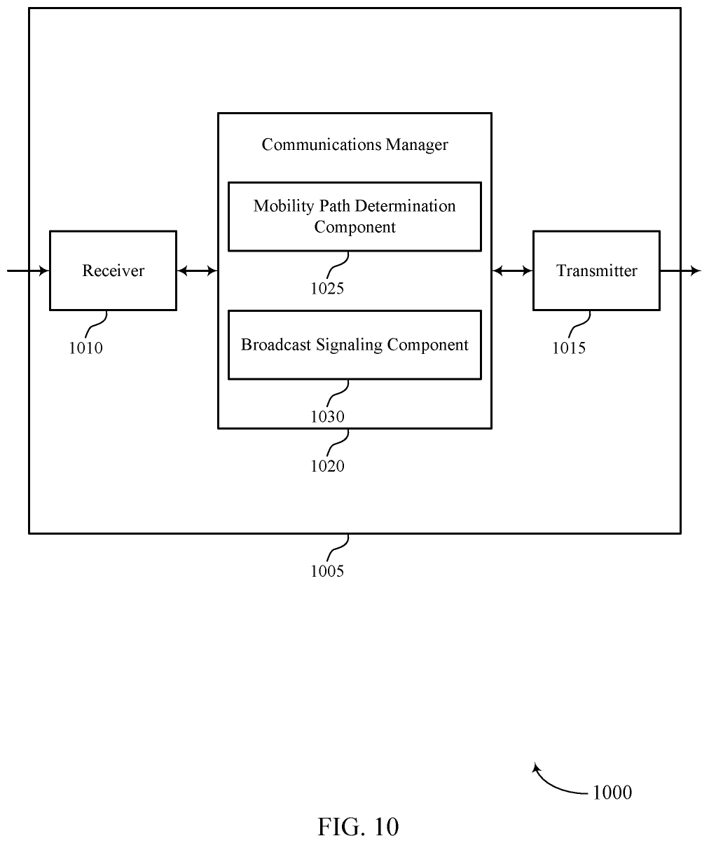

FIG. 10 shows a block diagram 1000 of a device 1005 that supports mobility procedures for NTN devices in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, and the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of mobility procedures for NTN devices as described herein. For example, the communications manager 1020 may include a mobility path determination component 1025 a broadcast signaling component 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The mobility path determination component 1025 is capable of, configured to, or operable to support a means for calculating a trajectory of the first cell with respect to a set of multiple UEs served by the first cell, the trajectory of the first cell based on ephemeris information associated with the NTN entity. The broadcast signaling component 1030 is capable of, configured to, or operable to support a means for transmitting, a broadcast signal from the first cell indicating respective parameters associated with one or more target cells of the NTN, the respective parameters associated with a cell selection or cell reselection from the first cell, where the one or more target cells and the respective parameters are based on the ephemeris information associated with the NTN entity.

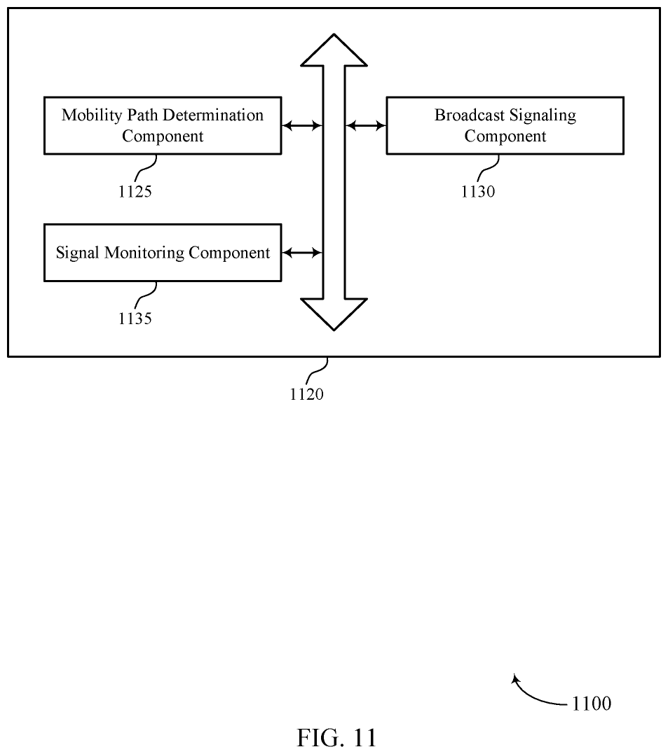

FIG. 11 shows a block diagram 1100 of a communications manager 1120 that supports mobility procedures for NTN devices in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of mobility procedures for NTN devices as described herein. For example, the communications manager 1120 may include a mobility path determination component 1125, a broadcast signaling component 1130, a signal monitoring component 1135, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The mobility path determination component 1125 is capable of, configured to, or operable to support a means for calculating a trajectory of the first cell with respect to a set of multiple UEs served by the first cell, the trajectory of the first cell based on ephemeris information associated with the NTN entity. The broadcast signaling component 1130 is capable of, configured to, or operable to support a means for transmitting, a broadcast signal from the first cell indicating respective parameters associated with one or more target cells of the NTN, the respective parameters associated with a cell selection or cell reselection from the first cell, where the one or more target cells and the respective parameters are based on the ephemeris information associated with the NTN entity.

In some examples, the respective parameters indicate a MIB and a respective SIB1 for each target cell of the one or more target cells.

In some examples, the respective MIB for a given target cell is indicated via a first string of bits and the respective SIB1 for the given target cell is indicated via a second string of bits.

In some examples, the respective MIB for a given target cell is indicated via a set of delta MIB parameters relative to a first MIB of the first cell, and the respective SIB1 for the given target cell is indicated via a set of delta SIB1 parameters relative to a first SIB1 of the first cell.

In some examples, the set of delta SIB1 parameters include one or more of a frequency, a TAC, a PLMN identifier, and a signal strength threshold for cell selection or cell reselection.

In some examples, the first cell includes a set of sub-cell sections each associated with a respective geographic coverage area. In some examples, a respective geographic location of each of the set of multiple UEs is within the respective geographic coverage area of a first sub-cell section of the set of sub-cell sections.

In some examples, the one or more target cells associated with the broadcast signal are based on the respective geographic location of each of the set of multiple UEs being with the respective geographic coverage area of the first sub-cell section.

In some examples, the signal monitoring component 1135 is capable of, configured to, or operable to support a means for receiving a respective TAC from each UE of the set of multiple UEs, where the respective geographic location of each of the set of multiple UEs is determined based on the respective TAC from each UE of the set of multiple UEs.

In some examples, the NTN entity includes the one or more target cells, one or more second NTN entities include the one or more target cells, or both.

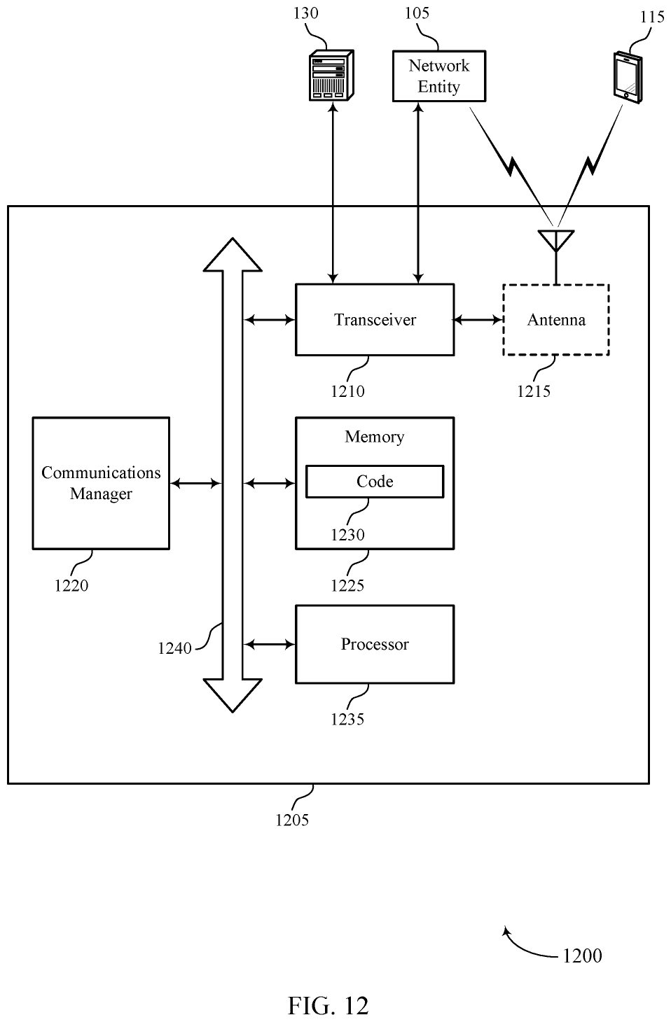

FIG. 12 shows a diagram of a system 1200 including a device 1205 that supports mobility procedures for NTN devices in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., a communication link 125, a backhaul communication link 120, a midhaul communication link 162, a fronthaul communication link 168).

The at least one memory 1225 may include RAM, ROM, or any combination thereof. The at least one memory 1225 may store computer-readable, computer-executable code 1230 including instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may contain, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting mobility procedures for NTN devices). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225). In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. As such, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for calculating a trajectory of the first cell with respect to a set of multiple UEs served by the first cell, the trajectory of the first cell based on ephemeris information associated with the NTN entity. The communications manager 1220 is capable of, configured to, or operable to support a means for transmitting, a broadcast signal from the first cell indicating respective parameters associated with one or more target cells of the NTN, the respective parameters associated with a cell selection or cell reselection from the first cell, where the one or more target cells and the respective parameters are based on the ephemeris information associated with the NTN entity.

By including or configuring the communications manager 1220 in accordance with examples as described herein, the device 1205 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of mobility procedures for NTN devices as described herein, or the at least one processor 1235 and the at least one memory 1225 may be otherwise configured to, individually or collectively, perform or support such operations.

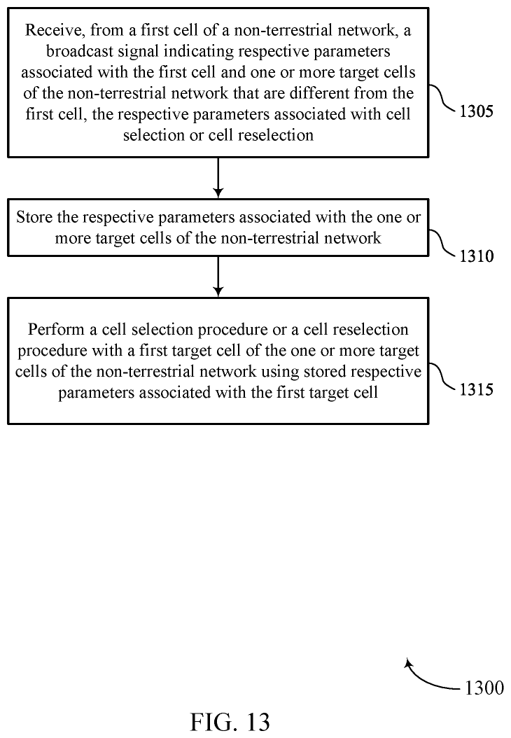

FIG. 13 shows a flowchart illustrating a method 1300 that supports mobility procedures for NTN devices in accordance with aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving, from a first cell of an NTN, a broadcast signal indicating respective parameters associated with the first cell and one or more target cells of the NTN that are different from the first cell, the respective parameters associated with cell selection or cell reselection. The operations of block 1305 may be performed in accordance with examples as disclosed herein. In some examples, aspects of the operations of 1305 may be performed by a broadcast signal monitoring component 725 as described with reference to FIG. 7.

At 1310, the method may include storing the respective parameters associated with the one or more target cells of the NTN. The operations of block 1310 may be performed in accordance with examples as disclosed herein. In some examples, aspects of the operations of 1310 may be performed by a parameter storing component 730 as described with reference to FIG. 7.

At 1315, the method may include performing a cell selection procedure or a cell reselection procedure with a first target cell of the one or more target cells of the NTN using stored respective parameters associated with the first target cell. The operations of block 1315 may be performed in accordance with examples as disclosed herein. In some examples, aspects of the operations of 1315 may be performed by a cell selection component 735 as described with reference to FIG. 7.

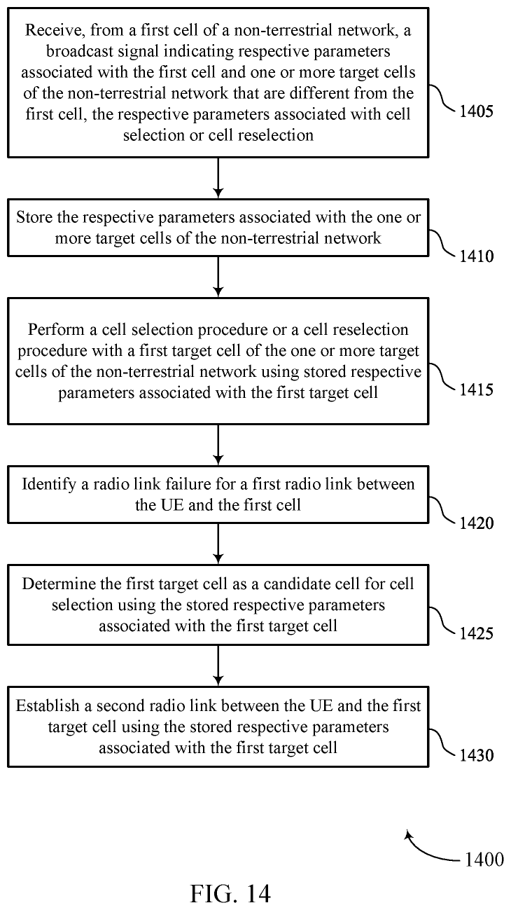

FIG. 14 shows a flowchart illustrating a method 1400 that supports mobility procedures for NTN devices in accordance with aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving, from a first cell of an NTN, a broadcast signal indicating respective parameters associated with the first cell and one or more target cells of the NTN that are different from the first cell, the respective parameters associated with cell selection or cell reselection. The operations of block 1405 may be performed in accordance with examples as disclosed herein. In some examples, aspects of the operations of 1405 may be performed by a broadcast signal monitoring component 725 as described with reference to FIG. 7.

At 1410, the method may include storing the respective parameters associated with the one or more target cells of the NTN. The operations of block 1410 may be performed in accordance with examples as disclosed herein. In some examples, aspects of the operations of 1410 may be performed by a parameter storing component 730 as described with reference to FIG. 7.

At 1415, the method may include performing a cell selection procedure or a cell reselection procedure with a first target cell of the one or more target cells of the NTN using stored respective parameters associated with the first target cell. The operations of block 1415 may be performed in accordance with examples as disclosed herein. In some examples, aspects of the operations of 1415 may be performed by a cell selection component 735 as described with reference to FIG. 7.

At 1420, the method may include identifying a radio link failure for a first radio link between the UE and the first cell. The operations of block 1420 may be performed in accordance with examples as disclosed herein. In some examples, aspects of the operations of 1420 may be performed by a link quality identification component 740 as described with reference to FIG. 7.

At 1425, the method may include determining the first target cell as a candidate cell for cell selection using the stored respective parameters associated with the first target cell. The operations of block 1425 may be performed in accordance with examples as disclosed herein. In some examples, aspects of the operations of 1425 may be performed by a candidate cell determination component 745 as described with reference to FIG. 7.

At 1430, the method may include establishing a second radio link between the UE and the first target cell using the stored respective parameters associated with the first target cell. The operations of block 1430 may be performed in accordance with examples as disclosed herein. In some examples, aspects of the operations of 1430 may be performed by a radio link establishing component 750 as described with reference to FIG. 7.

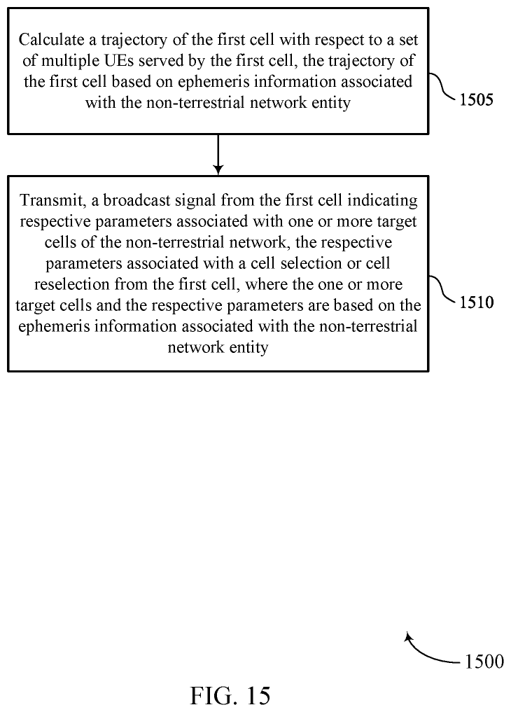

FIG. 15 shows a flowchart illustrating a method 1500 that supports mobility procedures for NTN devices in accordance with aspects of the present disclosure. The operations of the method 1500 may be implemented by a network entity or its components as described herein. For example, the operations of the method 1500 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1505, the method may include calculating a trajectory of the first cell with respect to a set of multiple UEs served by the first cell, the trajectory of the first cell based on ephemeris information associated with the NTN entity. The operations of block 1505 may be performed in accordance with examples as disclosed herein. In some examples, aspects of the operations of 1505 may be performed by a mobility path determination component 1125 as described with reference to FIG. 11.

At 1510, the method may include transmitting, a broadcast signal from the first cell indicating respective parameters associated with one or more target cells of the NTN, the respective parameters associated with a cell selection or cell reselection from the first cell, where the one or more target cells and the respective parameters are based on the ephemeris information associated with the NTN entity. The operations of block 1510 may be performed in accordance with examples as disclosed herein. In some examples, aspects of the operations of 1510 may be performed by a broadcast signaling component 1130 as described with reference to FIG. 11.

The following provides an overview of aspects of the present disclosure:

Aspect 1: A method for wireless communications at a UE, comprising: receiving, from a first cell of an NTN, a broadcast signal indicating respective parameters associated with the first cell and one or more target cells of the NTN that are different from the first cell, the respective parameters associated with cell selection or cell reselection; storing the respective parameters associated with the one or more target cells of the NTN; and performing a cell selection procedure or a cell reselection procedure with a first target cell of the one or more target cells of the NTN using stored respective parameters associated with the first target cell.

Aspect 2: The method of aspect 1, wherein performing the cell selection procedure or the cell reselection procedure comprises: identifying a radio link failure for a first radio link between the UE and the first cell; determining the first target cell as a candidate cell for cell selection using the stored respective parameters associated with the first target cell; and establishing a second radio link between the UE and the first target cell using the stored respective parameters associated with the first target cell.

Aspect 3: The method of aspect 2, further comprising: determining a first frequency associated with the first target cell using the stored respective parameters associated with the first target cell; and measuring, via the first frequency associated with the first target cell, one or more cell suitability criteria, wherein determining the first target cell as the candidate cell for cell selection or cell reselection is based at least in part on the first target cell satisfying the one or more cell suitability criteria.

Aspect 4: The method of aspect 3, wherein the one or more cell suitability criteria comprises one or more of a RSRP value of the first target cell, a RSRQ value of the first target cell, a cell load of the first target cell, a cell identifier of the first target cell, QoS parameters of the first target cell, a SNR value of the first target cell, the first frequency of the first target cell, a coverage area overlap between the first target cell and the first cell, a PLMN or TAC of the first target cell, or a status of the first target cell.

Aspect 5: The method of any of aspects 1 through 4, wherein the respective parameters indicate a respective MIB and a respective SIB1 for each target cell of the one or more target cells.

Aspect 6: The method of aspect 5, wherein the respective MIB for a given target cell is indicated via a first string of bits and the respective SIB1 for the given target cell is indicated via a second string of bits.

Aspect 7: The method of any of aspects 5 through 6, wherein the respective MIB for a given target cell is indicated via a set of delta MIB parameters relative to a first MIB of the first cell, and the respective SIB1 for the given target cell is indicated via a set of delta SIB1 parameters relative to a first SIB1 of the first cell.

Aspect 8: The method of aspect 7, wherein the set of delta SIB1 parameters comprise one or more of a frequency, a TAC, a PLMN identifier, and a signal strength threshold for cell selection or cell reselection.

Aspect 9: The method of any of aspects 1 through 8, wherein the first cell comprises a set of sub-cell sections each associated with a respective geographic coverage area; and a geographic location of the UE is within the respective geographic coverage area of a first sub-cell section of the set of sub-cell sections.

Aspect 10: The method of aspect 9, wherein the one or more target cells associated with the broadcast signal and the respective parameters associated with the one or more target cells are based at least in part on the geographic location of the UE being with the respective geographic coverage area of the first sub-cell section.

Aspect 11: The method of any of aspects 1 through 10, wherein the UE is moving relative to a terrestrial plane, performing a handover procedure comprises: measuring, via a respective frequency associated with each target cell of the one or more target cells within a range of a geographic location of the UE, a respective RSRP value; and determining one or more candidate cells for handover from the one or more target cells, wherein each candidate cell of the one or more candidate cells has a respective RSRP value that satisfies a threshold.

Aspect 12: A method for wireless communications at an NTN entity comprising a first cell of an NTN, comprising: calculating a trajectory of the first cell with respect to a plurality of UEs served by the first cell, the trajectory of the first cell based at least in part on ephemeris information associated with the NTN entity; and transmitting, a broadcast signal from the first cell indicating respective parameters associated with one or more target cells of the NTN, the respective parameters associated with a cell selection or cell reselection from the first cell, wherein the one or more target cells and the respective parameters are based at least in part on the ephemeris information associated with the NTN entity.

Aspect 13: The method of aspect 12, wherein the respective parameters indicate a respective MIB and a respective SIB1 for each target cell of the one or more target cells.

Aspect 14: The method of aspect 13, wherein the respective MIB for a given target cell is indicated via a first string of bits and the respective SIB1 for the given target cell is indicated via a second string of bits.

Aspect 15: The method of any of aspects 13 through 14, wherein the respective MIB for a given target cell is indicated via a set of delta MIB parameters relative to a first MIB of the first cell, and the respective SIB1 for the given target cell is indicated via a set of delta SIB1 parameters relative to a first SIB1 of the first cell.

Aspect 16: The method of aspect 15, wherein the set of delta SIB1 parameters comprise one or more of a frequency, a TAC, a PLMN identifier, and a signal strength threshold for cell selection or cell reselection.

Aspect 17: The method of any of aspects 12 through 16, wherein the first cell comprises a set of sub-cell sections each associated with a respective geographic coverage area; and a respective geographic location of each of the plurality of UEs is within the respective geographic coverage area of a first sub-cell section of the set of sub-cell sections.

Aspect 18: The method of aspect 17, wherein the one or more target cells associated with the broadcast signal are based at least in part on the respective geographic location of each of the plurality of UEs being with the respective geographic coverage area of the first sub-cell section.

Aspect 19: The method of any of aspects 17 through 18, further comprising: receiving a respective TAC from each UE of the plurality of UEs, wherein the respective geographic location of each of the plurality of UEs is determined based at least in part on the respective TAC from each UE of the plurality of UEs.

Aspect 20: The method of any of aspects 12 through 19, wherein the NTN entity comprises the one or more target cells, one or more second NTN entities comprise the one or more target cells, or both.

Aspect 21: A UE for wireless communications, comprising one or more memories storing processor-executable code, and one or more processors coupled with the one or more memories and individually or collectively operable to execute the code to cause the UE to perform a method of any of aspects 1 through 11.

Aspect 22: A UE for wireless communications, comprising at least one means for performing a method of any of aspects 1 through 11.

Aspect 23: A non-transitory computer-readable medium storing code for wireless communications, the code comprising instructions executable by a processor to perform a method of any of aspects 1 through 11.

Aspect 24: An NTN entity comprising a first cell of an NTN for wireless communications, comprising one or more memories storing processor-executable code, and one or more processors coupled with the one or more memories and individually or collectively operable to execute the code to cause the NTN entity comprising a first cell of an NTN to perform a method of any of aspects 12 through 20.

Aspect 25: An NTN entity comprising a first cell of an NTN for wireless communications, comprising at least one means for performing a method of any of aspects 12 through 20.

Aspect 26: A non-transitory computer-readable medium storing code for wireless communications, the code comprising instructions executable by a processor to perform a method of any of aspects 12 through 20.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive, from a first cell of a non-terrestrial network, a broadcast signal indicating respective parameters associated with the first cell and one or more target cells of the non-terrestrial network that are different from the first cell, the respective parameters associated with cell selection or cell reselection;
store the respective parameters associated with the one or more target cells of the non-terrestrial network; and
perform a cell selection procedure or a cell reselection procedure with a first target cell of the one or more target cells of the non-terrestrial network using stored respective parameters associated with the first target cell.

2. The UE of claim 1, wherein, to perform the cell selection procedure or the cell reselection procedure, the one or more processors are individually or collectively operable to execute the code to cause the UE to:
identify a radio link failure for a first radio link between the UE and the first cell;
determine the first target cell as a candidate cell for cell selection using the stored respective parameters associated with the first target cell; and
establish a second radio link between the UE and the first target cell using the stored respective parameters associated with the first target cell.

3. The UE of claim 2, wherein the one or more processors are individually or collectively further operable to execute the code to cause the UE to:
determine a first frequency associated with the first target cell using the stored respective parameters associated with the first target cell; and
measure, via the first frequency associated with the first target cell, one or more cell suitability criteria, wherein determining the first target cell as the candidate cell for cell selection or cell reselection is based at least in part on the first target cell satisfying the one or more cell suitability criteria.

4. The UE of claim 3, wherein the one or more cell suitability criteria comprises one or more of a reference signal received power value of the first target cell, a reference signal received quality value of the first target cell, a cell load of the first target cell, a cell identifier of the first target cell, quality of service parameters of the first target cell, a signal to noise ratio value of the first target cell, the first frequency of the first target cell, a coverage area overlap between the first target cell and the first cell, a public land mobile network or tracking area code of the first target cell, or a status of the first target cell.

5. The UE of claim 1, wherein the respective parameters indicate a respective master information block (MIB) and a respective system information block 1 (SIB1) for each target cell of the one or more target cells.

6. The UE of claim 5, wherein the respective MIB for a given target cell is indicated via a first string of bits and the respective SIB1 for the given target cell is indicated via a second string of bits.

7. The UE of claim 5, wherein the respective MIB for a given target cell is indicated via a set of delta MIB parameters relative to a first MIB of the first cell, and the respective SIB1 for the given target cell is indicated via a set of delta SIB1 parameters relative to a first SIB1 of the first cell.

8. The UE of claim 7, wherein the set of delta SIB1 parameters comprise one or more of a frequency, a tracking area code, a public land mobile network identifier, and a signal strength threshold for cell selection or cell reselection.

9. The UE of claim 1, wherein:
the first cell comprises a set of sub-cell sections each associated with a respective geographic coverage area; and
a geographic location of the UE is within the respective geographic coverage area of a first sub-cell section of the set of sub-cell sections.

10. The UE of claim 9, wherein the one or more target cells associated with the broadcast signal and the respective parameters associated with the one or more target cells are based at least in part on the geographic location of the UE being with the respective geographic coverage area of the first sub-cell section.

11. The UE of claim 1, wherein, the UE is moving relative to a terrestrial plane, and to perform a handover procedure the one or more processors are individually or collectively operable to execute the code to cause the UE to:
measure, via a respective frequency associated with each target cell of the one or more target cells within a range of a geographic location of the UE, a respective reference signal received power value; and
determine one or more candidate cells for handover from the one or more target cells, wherein each candidate cell of the one or more candidate cells has a respective reference signal received power value that satisfies a threshold.

12. A non-terrestrial network entity comprising a first cell of a non-terrestrial network, comprising:
one or more memories storing processor-executable code; and
one or more processors coupled with the one or more memories and individually or collectively operable to execute the code to cause the first cell to:
calculate a trajectory of the first cell with respect to a plurality of user equipments (UEs) served by the first cell, the trajectory of the first cell based at least in part on ephemeris information associated with the non-terrestrial network entity; and
transmit, a broadcast signal from the first cell indicating respective parameters associated with one or more target cells of the non-terrestrial network, the respective parameters associated with a cell selection or cell reselection from the first cell, wherein the one or more target cells and the respective parameters are based at least in part on the ephemeris information associated with the non-terrestrial network entity.

13. The first cell of claim 12, wherein the respective parameters indicate a respective master information block (MIB) and a respective system information block 1 (SIB1) for each target cell of the one or more target cells.

14. The first cell of claim 13, wherein the respective MIB for a given target cell is indicated via a first string of bits and the respective SIB1 for the given target cell is indicated via a second string of bits.

15. The first cell of claim 13, wherein the respective MIB for a given target cell is indicated via a set of delta MIB parameters relative to a first MIB of the first cell, and the respective SIB1 for the given target cell is indicated via a set of delta SIB1 parameters relative to a first SIB1 of the first cell.

16. The first cell of claim 15, wherein the set of delta SIB1 parameters comprise one or more of a frequency, a tracking area code, a public land mobile network identifier, and a signal strength threshold for cell selection or cell reselection.

17. The first cell of claim 12, wherein:
the first cell comprises a set of sub-cell sections each associated with a respective geographic coverage area; and
a respective geographic location of each of the plurality of UEs is within the respective geographic coverage area of a first sub-cell section of the set of sub-cell sections.

18. The first cell of claim 17, wherein the one or more target cells associated with the broadcast signal are based at least in part on the respective geographic location of each of the plurality of UEs being with the respective geographic coverage area of the first sub-cell section.

19. The first cell of claim 17, wherein the one or more processors are individually or collectively further operable to execute the code to cause the first cell to:
receive a respective tracking area code from each UE of the plurality of UEs, wherein the respective geographic location of each of the plurality of UEs is determined based at least in part on the respective tracking area code from each UE of the plurality of UEs.

20. The first cell of claim 12, wherein the non-terrestrial network entity comprises the one or more target cells, one or more second non-terrestrial network entities comprise the one or more target cells, or both.

21. A method for wireless communications at a user equipment (UE), comprising:
receiving, from a first cell of a non-terrestrial network, a broadcast signal indicating respective parameters associated with the first cell and one or more target cells of the non-terrestrial network that are different from the first cell, the respective parameters associated with cell selection or cell reselection;
storing the respective parameters associated with the one or more target cells of the non-terrestrial network; and
performing a cell selection procedure or a cell reselection procedure with a first target cell of the one or more target cells of the non-terrestrial network using stored respective parameters associated with the first target cell.

22. The method of claim 21, wherein performing the cell selection procedure or the cell reselection procedure comprises:
identifying a radio link failure for a first radio link between the UE and the first cell;
determining the first target cell as a candidate cell for cell selection using the stored respective parameters associated with the first target cell; and
establishing a second radio link between the UE and the first target cell using the stored respective parameters associated with the first target cell.

23. The method of claim 22, further comprising:
determining a first frequency associated with the first target cell using the stored respective parameters associated with the first target cell; and
measuring, via the first frequency associated with the first target cell, one or more cell suitability criteria, wherein determining the first target cell as the candidate cell for cell selection or cell reselection is based at least in part on the first target cell satisfying the one or more cell suitability criteria.

24. The method of claim 23, wherein the one or more cell suitability criteria comprises one or more of a reference signal received power value of the first target cell, a reference signal received quality value of the first target cell, a cell load of the first target cell, a cell identifier of the first target cell, quality of service parameters of the first target cell, a signal to noise ratio value of the first target cell, the first frequency of the first target cell, a coverage area overlap between the first target cell and the first cell, a public land mobile network or tracking area code of the first target cell, or a status of the first target cell.

25. The method of claim 21, wherein the respective parameters indicate a respective master information block (MIB) and a respective system information block 1 (SIB1) for each target cell of the one or more target cells.

26. The method of claim 25, wherein the respective MIB for a given target cell is indicated via a first string of bits and the respective SIB1 for the given target cell is indicated via a second string of bits.

27. The method of claim 25, wherein the respective MIB for a given target cell is indicated via a set of delta MIB parameters relative to a first MIB of the first cell, and the respective SIB1 for the given target cell is indicated via a set of delta SIB1 parameters relative to a first SIB1 of the first cell.

28. The method of claim 27, wherein the set of delta SIB1 parameters comprise one or more of a frequency, a tracking area code, a public land mobile network identifier, and a signal strength threshold for cell selection or cell reselection.

29. The method of claim 21, wherein:
the first cell comprises a set of sub-cell sections each associated with a respective geographic coverage area; and
a geographic location of the UE is within the respective geographic coverage area of a first sub-cell section of the set of sub-cell sections.

30. A method for wireless communications at a non-terrestrial network entity comprising a first cell of a non-terrestrial network, comprising:
calculating a trajectory of the first cell with respect to a plurality of user equipments (UEs) served by the first cell, the trajectory of the first cell based at least in part on ephemeris information associated with the non-terrestrial network entity; and
transmitting, a broadcast signal from the first cell indicating respective parameters associated with one or more target cells of the non-terrestrial network, the respective parameters associated with a cell selection or cell reselection from the first cell, wherein the one or more target cells and the respective parameters are based at least in part on the ephemeris information associated with the non-terrestrial network entity.
